(19) United States
(12) Patent Application Publication
(10) Pub. No.: US 2001/0032237 A1
(43) Pub. Date: Oct. 18, 2001

(54) Method of setting up internet server and method of setting information communication apparatus

(76) Inventors: Nobumasa Miyake, Kanagawa (JP); Hiroshi Uchida, Tokyo (JP); Sessyu Hanahara, Kanagawa (JP); Masakazu Kobayashi, Tokyo (JP)

Correspondence Address: William S. Frommer, Esq., FROMMER LAWRENCE & HAUG LLP, 745 Fifth Avenue, New York, NY, 10151, US

(21) Appl. No.: 09/755,581

(22) Filed: Jan. 5, 2001

(30) Foreign Application Priority Data
Jan. 6, 2000 (JP) 2000-005792

(51) Int. Cl. G06F 15/16; G06F 15/177

(52) U.S. Cl. 709/203; 709/220; 709/219

(57) ABSTRACT

A method of setting up an Internet server and a method of setting an information communication apparatus are disclosed. There are steps of storing in a storage medium setting information for connecting the information communication apparatus to the network in a state corresponding to a use environment of the information communication apparatus on the side of a client, and reading the setting information from the storage medium to connect the information communication apparatus to the network.

### BACKGROUND OF THE INVENTION

1. Field of the Invention

The present invention relates to a method of setting up an Internet server and a method of setting an information communication apparatus, and more particularly, is suitably applied for a setting method, for example, for connecting a computer as an information communication apparatus to the Internet.

2. Description of the Related Art

Conventionally, a personal computer, which is a user terminal, is connected, for example, to an all-in server (hereinafter referred to as the “server apparatus”) to access a service provider (ISP: Internet Service Provider) from the server apparatus through the Internet such that the service provider provides a variety of information to the personal computer through the Internet.

In this event, a user who manipulates the personal computer has previously entered setting information such as a telephone number for connection to the service provider into the server apparatus which is connected to the personal computer.

Then, the server apparatus places a call to a line reception of the service provider based on the entered setting information to ensure a telephone communication path, and transmits connection information entered by the user such as a connection ID, a password and so on to the service provider to open a session between the server apparatus and the service provider. Consequently, a communication path is established between the server apparatus and the service provider, so that the user sequentially acquires information provided by the service provider through the server apparatus and the personal computer.

Also, when the user utilizes an electronic mail service provided by the service provider, the user enters a mail ID, a password and information on a mail server into the server apparatus for receiving the electronic mail service, thereby allowing the user to access the mail server of the service provider to benefit from the electronic mail service such as transmission/reception of mails.

Further, as the user enters information for utilizing a World Wide Web (WWW) server or a Domain Name System (DNS) server from the personal computer, the user can benefit from a service of browsing a WWW home page.

However, when the user receives a variety of services from the service provider using the personal computer, the user must enter a large amount of setting information for connection to the service provider into the server apparatus which is connected to the personal computer, a problem arises in that the user suffers from tedious entry manipulation.

Also, if settings are erroneously made in entry manipulations for connection to the Internet when such a server apparatus is installed, adverse influences will exert external to the server apparatus on the Internet. Thus, techniques and knowledge on the network are indispensable for such entry manipulations, so that a technical expert must visit a site where the server is installed.

Further, in the conventional setting method for making a connection with a service provider by setting information entered into the server apparatus by the user, a variety of setting information can be simultaneously set to a plurality of personal computers. This results in a problem on the security in that someone may trap the setting information including a password and, using the information, connect to the service provider to receive a variety of information providing services and eavesdrop at mails of other persons.

In addition, some service providers may take actions to keep the user from knowing the setting information.

### SUMMARY OF THE INVENTION

In view of the foregoing, an object of this invention is to provide a method of setting up an Internet server and a method of setting an information communication apparatus that are capable of significantly improving the convenience.

The foregoing object and other objects of the invention have been achieved by the provision of a method of setting up an Internet server which comprises the steps of: receiving from a client information on the connecting environment of the Internet server to the Internet on the side of the client; generating setup information to connect the Internet server to the Internet according to the information on the connecting environment on the side of the client; and storing the setup information in a storage medium. The setup information is the information that will allow the client who received the Internet server and the storage medium to have the Internet server automatically set up with the set up information.

As a result, according to this method, the effort of the user to enter the setup information can be saved by having the setup information automatically set in the Internet server, thereby simplifying setting manipulations.

Also, according to this method, since a unique password is set in the storage medium, access to the Internet becomes possible only when the authorized user aware of the password uses the Internet server.

Furthermore, the present invention provides a method of setting up an Internet server which comprises the steps of: receiving from a distributor of the Internet server the Internet server and a storage medium related to the Internet server; and performing set up processing automatically to connect the Internet server to the Internet. The information stored in the storage medium is the information that is previously generated by the distributor of the Internet server according to the information pertaining to the connecting environment on the side of a client who installs the Internet server.

As a result, according to this method, the effort of the user to enter the setup information can be saved by having the setup information automatically set in the Internet server, thereby simplifying setting manipulations.

Also, according to this method, since a unique password is set in the storage medium, access to the Internet becomes possible only when the authorized user aware of the password uses the Internet server.

Moreover, the present invention provides a method of setting an information communication apparatus for connecting to a network which comprises: a first step of storing in a storage medium setting information for connecting the information communication apparatus to the network in a state corresponding to a use environment of the information communication apparatus on the side of a client; and a second step of reading the setting information from the storage medium to connect the information communication apparatus to the network.

As a result, according to this method, the effort of the user to enter the setting information can be saved correspondingly by having the setting information automatically set in the information communication apparatus, thereby simplifying setting manipulations.

Also, according to this method, since a unique password is set in the storage medium, access to the network becomes possible only when the authorized user aware of the password uses the information communication apparatus.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a block diagram illustrating the configuration of an information communication system according to one embodiment;

FIG. 2 is a block diagram illustrating the configuration of a server apparatus; and

FIG. 3 is a flow chart used for explaining a setting processing procedure.

### DETAILED DESCRIPTION OF THE EMBODIMENT

Preferred embodiments of this invention will be described with reference to the accompanying drawings:

(1) General Configuration of Information Communication System

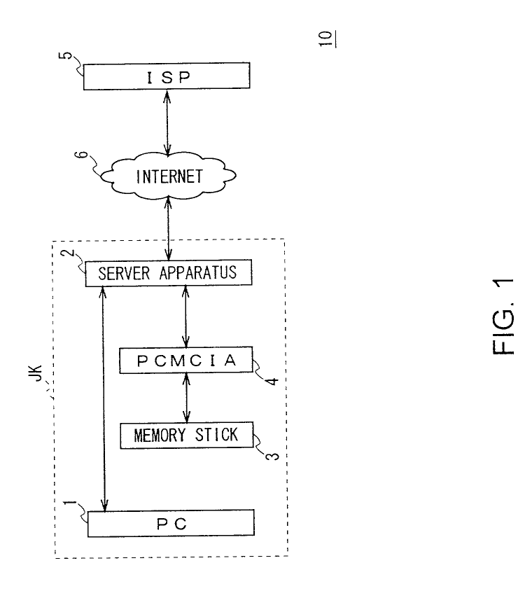

In FIG. 1, an information communication system, generally designated by reference numeral 10, comprises an information terminal device JK, for use by the user, which is comprised of a personal computer 1 and a server apparatus 2 interconnected with each other. As the server apparatus 2 is loaded with a memory stick 3 or the like, which is implemented by a semiconductor memory, the memory stick 3 automatically performs initial settings (set up) for connecting the server apparatus 2 to the Internet 6, thereby interconnecting the information terminal apparatus JK and a service provider (ISP: Internet Service Provider) 5 as information providing means for providing a variety of information through the Internet 6.

More specifically, the memory stick 3 connected to the server apparatus 2 causes the server apparatus 2 to communicate information with the memory stick 3 through a Personal Computer Memory Card International Association (PCMCIA) interface 4. In this event, the server apparatus 2 is configured to read predetermined setting information from the memory stick 3 loaded therein based on a predetermined application program which has been previously stored.

(2) Detailed Configuration of Server Apparatus

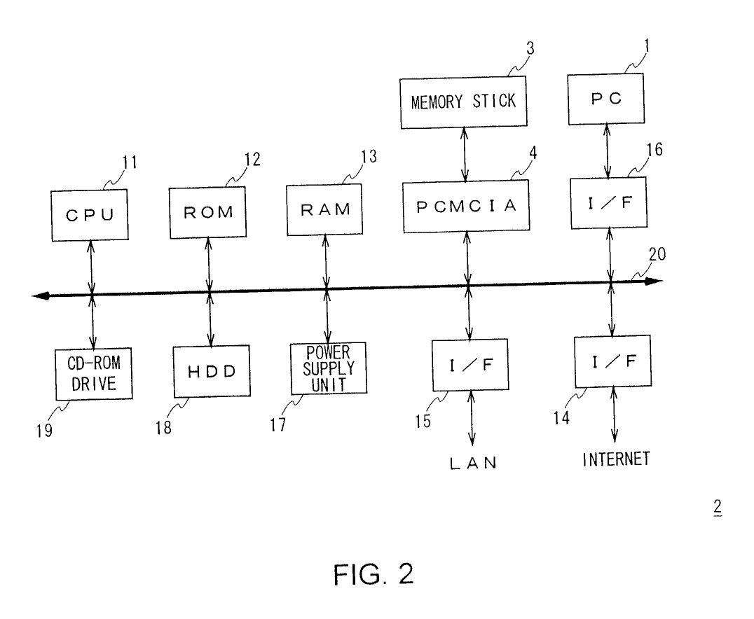

Actually, the server apparatus 2 comprises a Central Processing Unit (CPU) 11; a Read Only Memory (ROM) 12; the Random Access Memory (RAM) 13; a PCMCIA interface 4; interface circuits 14, 15, 16; a power supply unit 17; a hard disk drive unit 18; and a Compact Disc Read-Only Memory (CD-ROM) drive unit 19, all of which are interconnected through a bus 20, as illustrated in FIG. 2. The server apparatus 2 is connected to the Internet 6 and an intranet (not shown) such as Local Area Network (LAN) through the interface circuits 14, 15, connected to the personal computer 1 through the interface circuit 16, and connected to the memory stick 3 through the PCMCIA interface 4.

In this event, the server apparatus 2 is powered through the power supply unit 16 to start, and the CPU 11 reads a predetermined operation program stored in the ROM 12 to the RAM 13 through the bus 19 to start operating.

Then, as software implemented on a CD-ROM having a predetermined application program recorded thereon is inserted into the CD-ROM drive unit 19, the CPU 11 fetches the application program of the software into the RAM 13 through the bus 20. subsequently, as the memory stick 3 is loaded into the PCMCIA interface 4, the CPU 11 sequentially reads predetermined setting information from the loaded memory stick 3 through the PCMCIA interface 4 and the bus 19 based on the application program.

The setting information read from the memory stick 3 in this event includes information required by the CPU 11 for connection to the Internet 6, and is comprised, for example, of the host names, Internet Protocol (IP) addresses and subnet mask of Local Area Network (LAN) and Wide Area Network (WAN), IP address of a default router, IP address and host name of a secondary Domain Name System (DNS), and domain name, network address and so on of the user.

For reference, the memory stick 3 is designed to allow an authorized user to use it in association with the server apparatus 2. Specifically, the setting information of the memory stick 3 allows the user to set a unique password, so that when the user has previously notified an operator of the user information comprising his IP address, password, domain name, desired environmental information and so on through an appropriate means such as a telephone call, a postal service or the like, the operator performs settings based on the user information, stores setting information in the memory stick 3, and supplies the user with the setting information through a postal service or the like.

Then, the CPU 11 compares the password in the setting information with a password based on the application program of the software, reads the setting information from the memory stick 3 when the passwords match each other, stores the setting information in the hard disk drive unit 17 for backup, and connects to the Internet 6 through the interface circuit 14 based on the setting information.

Also, when the user changes the environmental settings, the CPU 11 backs up the contents of the change in the loaded memory stick 3 through the PCMCIA interface 4 to update the environmental information.

In this way, the server apparatus 2 can be automatically set up only by loading the memory stick 3 without the need for manual setting based on the user's manipulations from the personal computer 1 through the interface circuit 16, thereby permitting the user to connect to the Internet 6 from the personal computer 1 sequentially through the interface circuit 16, the bus 20 and the interface circuit 14 to acquire a variety of desired information from the service provider 5 through the Internet 6.

Also, even if the server apparatus 2 is reset, for example, due to some trouble or the like, the memory stick 3 may be loaded so that the server apparatus 2 can be reset to a default state (an environmental state before the trouble) stored in the memory stick 3.

For reference, the server apparatus 2 is also configured such that it may be remotely manipulated, for example, by another host (not shown) within a LAN connected through the interface circuit 15 to set up a connection to the Internet 6.

(3) Setting Processing Procedure

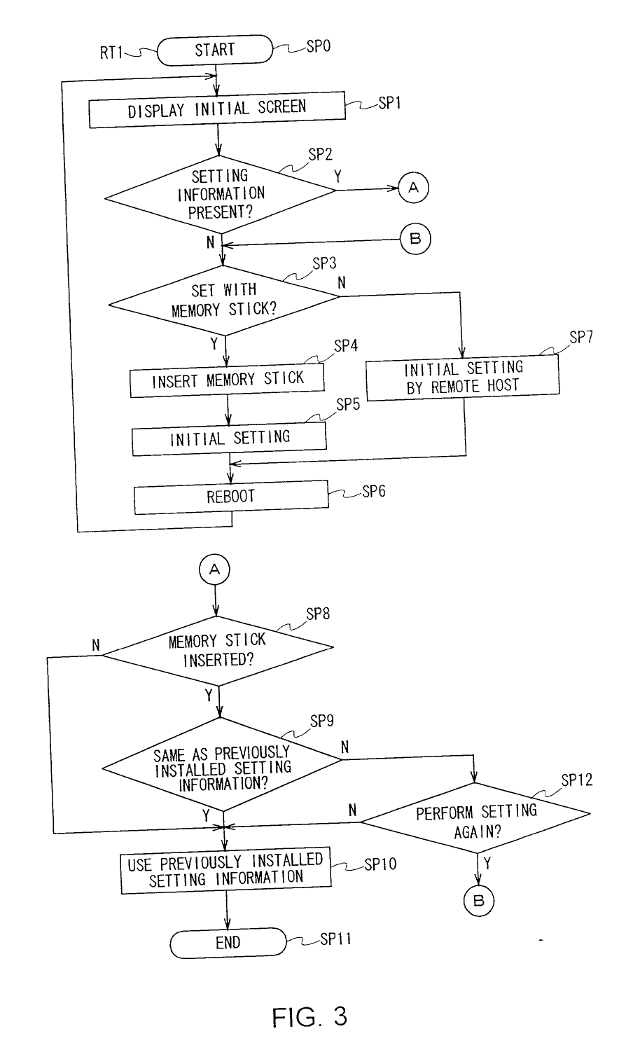

Actually, in the information communication system 10, as the server apparatus 2 is powered on, the CPU 11 in the server apparatus 2 starts a setting processing procedure RT1 as illustrated in FIG. 3 to perform initial settings for connection to the Internet 6. Specifically, the CPU 11 starts the setting processing procedure RT1 from step SP0 as the server apparatus 2 is powered on. Then, the CPU 11 proceeds to next step SP1 where an initial screen including a message “WELCOME” is displayed on a display unit (not shown) of the personal computer connected through the interface circuit 16.

Next, the CPU 11 proceeds to step SP2 to determine whether or not setting information has been already installed for initial setting. When a negative result is returned at step SP2 due to the fact that the setting information has not been installed, the CPU 11 proceeds to subsequent step SP3 to determine whether or not the memory stick 3 is used for setting up a connection to the Internet 6.

When an affirmative result is returned at step SP3 based on the fact that the user manipulates the personal computer 1 to set up using the memory stick 3, the CPU 11 proceeds to next step SP4 to display on a display unit of the personal computer 1 a message instructing the user to insert the corresponding memory stick 3 into the PCMCIA interface 4. As the user responsively inserts the memory stick 3 into the PCMCIA interface 4, the CPU 11 proceeds to subsequent step SP5.

Then, the CPU 11 reads setting information from the inserted memory stick 3 to set up a connection to the Internet 6 based on the setting information, and then proceeds to next step SP6 to reboot, followed by returning to step SP1.

On the other hand, when a negative result is returned at step SP3 based on the fact that the user manipulates the personal computer 1 to reject the setup using the memory stick 3, the CPU 11 proceeds to step SP7 to display on the display unit of the personal computer 1 a message which prompts settings given from another host (not shown) within the LAN connected through the interface circuit 15. After a connection to the Internet 6 has been set through remote manipulations performed by the host, the CPU proceeds to step SP6 to reboot, followed by returning to step SP1.

Subsequently, the CPU 11 repeats steps SP1-SP6 or a loop of steps SP1-SP2-SP3-SP7-SP6 until an affirmative result is returned at step SP2.

On the other hand, when an affirmative result is returned at step SP2 due to the fact that the setting information for the setup has been already installed, the CPU 11 proceeds to step SP8 to determine whether or not the memory stick 3 has been inserted.

When an affirmative result is returned at step SP8 due to the fact that the memory stick 3 has been inserted, the CPU 11 proceeds to subsequent step SP9 to determine whether or not the previously set setting information for the setup has the same contents as the setting information in the inserted memory stick 3. When an affirmative result is returned due to the fact that both setting information is identical to each other, the CPU 11 proceeds to next step SP10 where the previously set setting information is used, followed by proceeding to step SP11 to terminate the setting processing procedure RT1.

On the other hand, when a negative result is returned at step SP8 due to the fact that the memory stick 3 is not inserted, the CPU 11 proceeds immediately to step SP10 to use the previously set setting information, and proceeds to step SP11 to terminate the setting processing procedure RT1.

When a negative result is returned at step SP9 due to the fact that the previously set setting information for setup is different from the setting information in the inserted memory stick 3, the CPU 11 proceeds to step S12 to determine whether or not the setup is performed again based on the setting information in the inserted memory stick 3.

Then, when a negative result is returned at step SP12 due to the fact that the user manipulates the personal computer 1 not to again perform the setup, the CPU 11 proceeds to step SP10 to use the previously set setting information.

On the other hand, when an affirmative result is returned at step SP12 due to the fact that the user manipulates the personal computer to again perform the setup, the CPU 11 returns to step SP3 to determine whether or not the memory stick 3 is used for the setup. Subsequently, the CPU 11 executes a sequence of steps SP4-SP5-SP6-SP1 or steps SP7-SP6-SP1 in a manner similar to the above, and then repeats steps SP1-SP6 or a loop of steps SP1-SP2-SP3-SP7-SP6 until an affirmative result is returned at step SP2.

When an affirmative result is eventually returned at step SP2 and an affirmative result is returned at step SP9, the CPU 11 proceeds to step SP10 to use the previously installed setting information, and proceeds to step SP12 to terminate the setting processing procedure RT1.

In this way, the server apparatus 2 can automatically set up a connection to the Internet 6 only through simple manipulations involving the insertion of the memory stick 3 into the PCMCIA interface 4.

(4) Operation and Effects of Embodiment

In the information communication system 10 configured as described above, the setting information for use in a connection to the Internet 6 has been previously stored in the memory stick 3 which is removable to the server apparatus 2. As the memory stick 3 is loaded into the server apparatus 2, the server apparatus 2 reads the setting information from the loaded memory stick 3 to automatically perform the initial setting for connection to the Internet 6 based on the setting information.

Therefore, since the information communication system 10 can eliminate the effort of user to manually enter setting information for connecting the server apparatus 2 to the Internet 6 by automatically setting up the connection only through simple manipulations which involve loading the predetermined memory stick 3 into the server apparatus 2, so that the setting manipulations can be simplified.

In this event, since the setting information for connecting the server apparatus 2 to the Internet 6 is supplied to the user as stored in the memory stick 3 by the operator, the operator need not visit the site for the setting through the network, as is the case with the prior art, thereby making it possible to prevent other persons from eavesdropping on the setting information.

Also, a password unique to the user is previously included in the setting information in the memory stick 3 to allow the use of the memory stick 3 on condition that the exact password is entered, so that even if a third person unaware of the password steals the memory stick 3, an access to the Internet 6 is difficult for him.

Further, even if the information communication apparatus fails during its use, the setting information is stored in a recording medium which can therefore be used to restore the information communication apparatus to a default state.

According to the foregoing configuration, the setting information for connecting the server apparatus 2 to the Internet 6 is previously stored in the memory stick 3 such that only the memory stick 3 loaded into the server apparatus 2 allows the server apparatus 2 to automatically perform initial settings based on the setting information in the loaded memory stick 3. It is therefore possible to save the effort of the user to manually set setting information for connecting the server apparatus 2 to the Internet 6 to simplify the setting manipulations, leading to the realization of a method of setting the server apparatus 2 which is capable of significantly improving the convenience.

Also, for the use of the memory stick 3, a password unique to the user is set such that the memory stick 3 can be used only when the password stored in the memory stick 3 matches a password previously set in the server apparatus 2 to permit an access to the Internet 6.

Consequently, it is possible to realize a method of setting the server apparatus 2 which ensures significantly higher security.

(5) Other Embodiments

The foregoing embodiment has been described for an application of the memory stick 3 which is a semiconductor memory removably mounted to the server apparatus 2 as a storage medium. The present invention, however, is not limited to this particular form of storage medium. In essence, a variety of other external storage media can be widely applied, for example, an IC card, a floppy disk and so on, as long as they are storage media for storing the setting information for connection to the Internet.

Also, the foregoing embodiment has been described in connection with the server apparatus 2 which is used as the information communication apparatus to receive a variety of services from the service provider 5 connected thereto through the Internet 6 as a communication path. The present invention, however, is not limited to this configuration but can be widely applied to an access to a particular communication server which provides a variety of information.

According to the present invention as described above, a method of setting up an Internet server comprises the steps of: receiving from a client information on the connecting environment of the Internet server to the Internet on the side of the client; generating setup information to connect the Internet server to the Internet according to the information on the connecting environment on the side of the client; and storing the setup information in a storage medium. The setup information is the information that will allow the client who received the Internet server and the storage medium to have the Internet server automatically set up with the set up information. Consequently, it is possible to realize the method of setting up an Internet server which can significantly improve the convenience.

Also, since a unique password is set in the storage medium, access to the Internet becomes possible only when the authorized user aware of the password uses the information communication apparatus.

Consequently, it is possible to realize a method of setting up an Internet server which ensures significantly higher security.

Furthermore, a method of setting up an Internet server comprises the steps of: receiving from a distributor of the Internet server the Internet server and a storage medium related to the Internet server; and performing set up processing automatically to connect the Internet server to the Internet. The information stored in the storage medium is the information that is previously generated by the distributor of the Internet server according to the information pertaining to the connecting environment on the side of a client who installs the Internet server. Consequently, it is possible to realize the method of setting up an Internet server which can significantly improve the convenience.

Also, since a unique password is set in the storage medium, access to the Internet becomes possible only when the authorized user aware of the password uses the information communication apparatus.

Consequently, it is possible to realize a method of setting up an Internet server which ensures significantly higher security.

Moreover, a method of setting an information communication apparatus for connecting to a network comprises: a first step of storing in a storage medium setting information for connecting the information communication apparatus to the network in a state corresponding to a use environment of the information communication apparatus on the side of a client; and a second step of reading the setting information from the storage medium to connect the information communication apparatus to the network. Consequently, it is possible to realize the method of setting an information communication apparatus which can significantly improve the convenience.

Also, since a unique password is set in the storage medium, access to the network becomes possible only when the authorized user aware of the password uses the information communication apparatus.

Consequently, it is possible to realize a method of setting an information communication apparatus which ensures significantly higher security.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

What is claimed is:

1. A method of setting up an Internet server, comprising the steps of:
receiving from a client information on the connecting environment of said Internet server to the Internet on the side of the client;
generating setup information to connect said Internet server to the Internet according to the information on the connecting environment on the side of said client; and
storing said setup information in a storage medium,
wherein said setup information is the information that will allow the client who received said Internet server and said storage medium to have said Internet server automatically set up with said set up information.

2. The method of setting up an Internet server according to claim 1, wherein
said setup information includes at least IP address of said Internet server, host name and domain name of a client.

3. The method of setting up an Internet server according to claim 1, wherein
said storage medium stores a unique password pertaining to said Internet server,
wherein said password is the information that enables setup processing for said Internet server only when said password matches to a password which is set up in said Internet server at the time of setting up by said client.

4. A method of setting up an Internet server, comprising the steps of:
receiving from a distributor of said Internet server said Internet server and a storage medium related to said Internet server; and
performing set up processing automatically to connect said Internet server to the Internet;
wherein information stored in said storage medium is the information that is previously generated by the distributor of said Internet server according to the information pertaining to the connecting environment on the side of a client who installs said Internet server.

5. A method of setting an information communication apparatus for connecting to a network, said method comprising:
a first step of storing in a storage medium setting information for connecting said information communication apparatus to said network in a state corresponding to a use environment of said information communication apparatus on the side of a client; and
a second step of reading said setting information from said storage medium to connect said information communication apparatus to said network.

6. The method of setting an information communication apparatus according to claim 5, wherein
said first step stores a unique password in said storage medium together with said setting information; and
said second step compares said password with a password previously set in said information communication apparatus, and connects said information communication apparatus to said network when said password matches the password previously set in said information communication apparatus.

7. The method of setting an information communication apparatus according to claim 6, wherein
said storage medium comprises a semiconductor memory removably mounted to said information communication apparatus.
